(19) United States
(12) Patent Application Publication
(10) Pub. No.: US 2023/0017284 A1
(43) Pub. Date: Jan. 19, 2023

(54) APPARATUS AND A METHOD FOR ELECTRICITY GENERATION

(71) Applicant: HITESH GULABRAI DESAI, MUMBAI (IN)

(72) Inventor: HITESH GULABRAI DESAI, MUMBAI (IN)

(21) Appl. No.: 16/982,070

(22) PCT Filed: Aug. 21, 2020
(86) PCT No.: PCT/IB2020/057848

§ 371 Date: Sep. 18, 2020

(30) Foreign Application Priority Data
Apr. 2, 2020 (IN) 202021014659

(51) Int. Cl. F03D 7/06; H02K 7/18; F03D 3/04

(52) U.S. Cl. CPC F03D 7/06; H02K 7/183; F03D 3/049

(57) ABSTRACT

An apparatus for electricity generation is provided. The apparatus includes an air handling unit which absorbs air from an atmosphere and regulates a velocity of flow of the air. The apparatus also includes a hollow chamber which includes a first end and a second end, and provides a passage for the air. Further, the apparatus includes at least two conduits which includes an inlet end and an outlet end respectively, and receives the air from the hollow chamber. The apparatus also includes an electric power generation unit which includes a rotor which rotates at a pre-defined rotation speed, an electricity generator which generates a pre-defined amount of electricity and multiple outlets which releases the air. Furthermore, the apparatus includes a power management unit, wherein an electric power supply from the electric power generation unit is fed back to power the air handling unit.

This National Phase Application claims priority from a Complete patent application filed in India having Patent Application No. 202021014659, filed on Apr. 2, 2020, and titled “AN APPARATUS AND A METHOD FOR ELECTRICITY GENERATION”.

### FIELD OF INVENTION

Embodiments of a present invention relate to generation of electricity, and more particularly, to an apparatus and a method for electricity generation.

### BACKGROUND

Electricity generation is the process of generating electric power from sources of primary energy. The primary energy is an energy form found in nature that has not been subjected to any human engineered conversion process. The primary energy can be non-renewable or renewable. The renewable energy sources are solar energy, wind energy, tidal energy, geothermal energy and the like. However, an approach of using solar energy as a primary energy source for electricity generation leads to inconvenience and inefficiency as sunlight is available only during daytime.

Further, in another approach, wind energy is used as a primary energy source for electricity generation. However, in such approach, speed of wind is not constant thereby affecting the efficiency of a wind turbine. Also, conventional wind turbines are expensive as the process of purchasing, transporting and installing wind turbines involves a huge cost.

Hence, there is a need for an improved apparatus and a method for electricity generation which addresses the aforementioned issues.

### BRIEF DESCRIPTION

In accordance with one embodiment of the disclosure, an apparatus for electricity generation is provided. The apparatus includes an air handling unit, wherein the air handling unit is configured to absorb air from an atmosphere. The air handling unit is also configured to regulate a velocity of flow of the air absorbed by the air handling unit. The apparatus also includes a hollow chamber of a pre-defined length, wherein the hollow chamber includes a first end and a second end. The first end of the hollow chamber is mechanically coupled to the air handling unit and the hollow chamber is configured to provide a passage for the air absorbed by the air handling unit.

Further, the apparatus also includes at least two conduits, wherein the at least two conduits include an inlet end and an outlet end respectively. The at least two conduits are configured to receive the air from the hollow chamber and the inlet end of each of the at least two inlets is mechanically coupled to a lateral surface of the hollow chamber. The apparatus also includes an electric power generation unit mechanically coupled to the outlet inlet end of each of the at least two conduits. The electric power generation unit includes a rotor, wherein the rotor is configured to rotate at a pre-defined rotation speed based upon a conduit outlet air flow velocity of the air received via the at least two conduits.

Further, the electric power generation unit also includes an electricity generator, wherein the electricity generator is configured to generate a pre-defined amount of electricity depending upon the pre-defined rotation speed of the rotor and the electricity generator is mechanically coupled to the rotor via a rotating shaft. The electric power generation unit also includes a plurality of outlets on a surface of the electric power generation unit, wherein the plurality of outlets is configured to release the air received by the at least two conduits. Furthermore, the apparatus includes a power management unit electrically coupled to the electric power generation unit, wherein an electric power supply from the electric power generation unit is fed back to power the air handling unit.

In accordance with another embodiment, a method for electricity generation is provided. The method includes absorbing air from an atmosphere. The method also includes regulating a velocity of flow of the air absorbed by an air handling unit. The method also includes providing a passage for the air absorbed by the air handling unit. The method also includes receiving the air from a hollow chamber. The method also includes rotating a rotor at a pre-defined rotation speed based upon a conduit outlet air flow velocity of the air received via at least two conduits.

Further, the method also includes generating a pre-defined amount of electricity depending upon the pre-defined rotation speed of the rotor. The method also includes releasing the air received by the at least two conduits. The method also includes feeding back an electric power supply from an electricity generator to the air handling unit.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a front view of a schematic representation of an apparatus for electricity generation in accordance with an embodiment of the present disclosure;

FIG. 2 is a side view of a schematic representation of a section comprising the rotor of FIG. 1 in accordance with an embodiment of the present disclosure; and

FIG. 3 is a flow chart representing steps involved in a method for electricity generation in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to an apparatus for electricity generation. The apparatus includes an air handling unit, wherein the air handling unit is configured to absorb air from an atmosphere. The air handling unit is also configured to regulate a velocity of flow of the air absorbed by the air handling unit. The apparatus also includes a hollow chamber of a pre-defined length, wherein the hollow chamber includes a first end and a second end. The first end of the hollow chamber is mechanically coupled to the air handling unit and the hollow chamber is configured to provide a passage for the air absorbed by the air handling unit.

Further, the apparatus also includes at least two conduits, wherein the at least two conduits include an inlet end and an outlet end respectively. The at least two conduits are configured to receive the air from the hollow chamber and the inlet end of each of the at least two inlets is mechanically coupled to a lateral surface of the hollow chamber. The apparatus also includes an electric power generation unit mechanically coupled to the outlet inlet end of each of the at least two conduits. The electric power generation unit includes a rotor, wherein the rotor is configured to rotate at a pre-defined rotation speed based upon a conduit outlet air flow velocity of the air received via the at least two conduits.

Further, the electric power generation unit also includes an electricity generator, wherein the electricity generator is configured to generate a pre-defined amount of electricity depending upon the pre-defined rotation speed of the rotor and the electricity generator is mechanically coupled to the rotor via a rotating shaft. The electric power generation unit also includes a plurality of outlets on a surface of the electric power generation unit, wherein the plurality of outlets is configured to release the air received by the at least two conduits. Furthermore, the apparatus includes a power management unit electrically coupled to the electric power generation unit, wherein an electric power supply from the electric power generation unit is fed back to power the air handling unit.

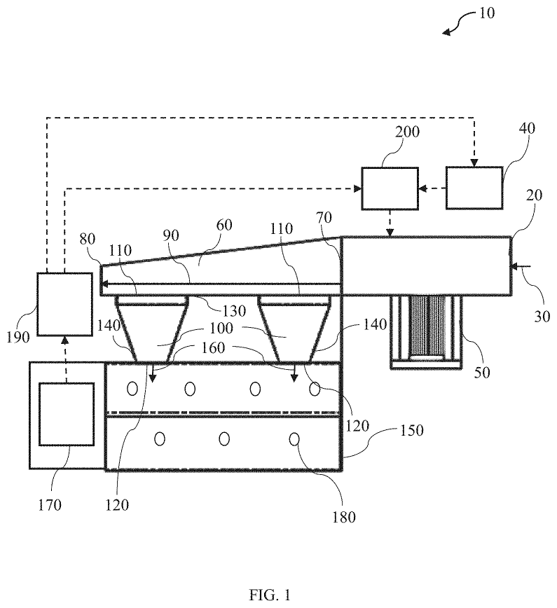

FIG. 1 is a front view of a schematic representation of an apparatus 10 for electricity generation in accordance with an embodiment of the present disclosure. The apparatus 10 includes an air handling unit 20, wherein the air handling unit 20 absorbs air from an atmosphere. The air handling unit 20 also regulates a velocity 30 of flow of the air absorbed by the air handling unit 20. In one embodiment, the air handling unit 20 is initially powered by a power supply unit 40. In such embodiment, the power supply unit 40 includes a battery. In one embodiment, the battery includes a rechargeable battery. In an alternate embodiment, the battery includes a non-rechargeable battery.

In one embodiment, the air handling unit 20 includes one or more motors 50. In such embodiment, the one or more motors 50 are used to operate the air handling unit 20. In such embodiment, the air handling unit 20 includes one or more blowers which absorb the air from the atmosphere and then regulates the velocity 30 of the flow of the air absorbed. In one embodiment, the air handling unit 20 consumes an input power of about 2200 watt in order to provide the air absorbed by the air handling unit 20 the flow of about 4800 cubic feet per minute (CFM).

The apparatus 10 also includes a hollow chamber 60 of a pre-defined length, wherein the hollow chamber 60 includes a first end 70 and a second end 80. In one embodiment, the pre-defined length of the hollow chamber 60 is about 1150 millimetre (mm).

In one embodiment, the hollow chamber 60 includes a cross-sectional area that is progressively decreasing from the first end 70 of the hollow chamber 60 to the second end 80 of the hollow chamber 60. In such embodiment, the cross-sectional area includes the cross-sectional area of the hollow chamber 60, wherein the hollow chamber 60 is trapezoidal prism in shape. In one embodiment, a first end length of one of multiple first end edges of a first end cross-section of the first end 70 of the hollow chamber 60 is about 300 mm. In one embodiment, a second end length of one of multiple second edges of a second end cross-section of the second end 80 of the hollow chamber 60 is about 150 mm. The first end 70 of the hollow chamber 60 is mechanically coupled to the air handling unit 20 and the hollow chamber 60 provides a passage 90 for the air absorbed by the air handling unit 20.

Further, the apparatus 10 also includes at least two conduits 100, wherein the at least two conduits 100 include an inlet end 110 and an outlet end 120 respectively. The at least two conduits 100 receive the air from the hollow chamber 60 and the inlet end 110 of each of the at least two conduits 100 is mechanically coupled to a lateral surface 130 of the hollow chamber 60. In one embodiment, the at least two conduits 100 is trapezoidal prism in shape. In such embodiment, the inlet end 110 is rectangular in shape and area of the inlet end 110 is about 306 mm×348 mm. In such another embodiment, the outlet end 120 is square in shape and the area of the outlet end 120 is about 140 mm×140 mm. In one embodiment, an angle formed by two edges 140 of the at least two conduits 100 is about 36.87 degree. In one embodiment, the shape of the at least two conduits 100 also regulates the velocity 30 of the flow of the air absorbed by the air handling unit 20. In one embodiment, a distance between the at least two conduits 100 is about 355 mm.

The apparatus 10 also includes an electric power generation unit 150 mechanically coupled to the outlet end 120 of each of the at least two conduits 100. The electric power generation unit 150 includes a rotor (not shown in FIG. 1), wherein the rotor rotates at a pre-defined rotation speed based upon a conduit outlet air flow velocity 160 of the air received via the at least two conduits 100. In one embodiment, the conduit outlet air flow velocity 160 of the air received via the at least two conduits 100 is calculated manually using following formula:

Conduit outlet air flow velocity (v)=V/A (1)

In such embodiment, ‘V’ is volume of the air received via the at least two conduits 100 and ‘A’ is two times the area of the outlet end 120. Further, in one embodiment, when the flow of the air received via the at least two conduits 100 is about 4800 CFM, the volume of the air received via the at least two conduits 100 is calculated using following formula:

$$Volume of the air ( V ) = 4800 * 0.00047194745 = 2.2653 {m}^{3} / s \qquad ( 2 )$$

In such embodiment, the volume of the air obtained is about 2.2653 meter³/second (m³/s). Thus, the conduit outlet air flow velocity 160 upon substitution of a value obtained for the volume of the air using the formula in an equation (2) and two times the area of the outlet end 120 in the formula of the equation (1) is about:

v=2.2653/0.0392=57.79 m/s (3)

Thus, the conduit outlet velocity obtained is about 57.79 meter/second (m/s). Further, the electric power generation unit 150 also includes an electricity generator 170, wherein the electricity generator 170 is configured to generate a pre-defined amount of electricity depending upon the pre-defined rotation speed of the rotor and the electricity generator 170 is mechanically coupled to the rotor via a rotating shaft (not shown in FIG. 1).

Furthermore, the electric power generation unit 150 also includes multiple outlets 180 on a surface of the electric power generation unit 150. The multiple outlets 180 release the air received by the at least two conduits 100. In one embodiment, the multiple outlets 180 include multiple holes on the surface of the electric power generation unit 150. The apparatus 10 includes a power management unit 190 electrically coupled to the electric power generation unit 150, wherein an electric power supply from the electric power generation unit 150 is fed hack to power the air handling unit 20. In one embodiment, the electric power supply from the electric power generation unit 150 is fed back to power the air handling unit 20 via a changeover switch 200 upon generation of the pre-defined amount of the electricity by the electricity generator 170.

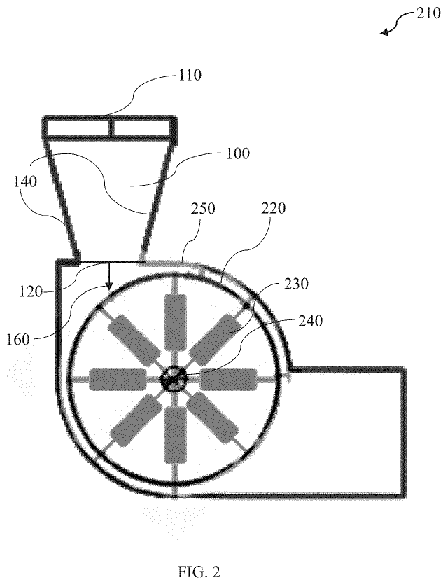

FIG. 2 is a side view of a schematic representation of a section 210 comprising the rotor 220 of FIG. 1 in accordance with an embodiment of the present disclosure. In such embodiment, the rotor 220 rotates at the pre-defined rotation speed based upon the conduit outlet air flow velocity 160 of the air received via the at least two conduits 100. In one embodiment, the rotor 220 includes multiple blades 230, wherein a count of the multiple blades 230 includes eight number of blades. In one embodiment, a diameter of the rotor 220 is about 450 mm and a length of the rotor 220 is about 1000 mm. In one embodiment, a diameter of the rotating shaft 240 is about 45 mm. In one embodiment, the conduit outlet air flow velocity 160 of the air received via the at least two conduits 100 produce a dynamic pressure, wherein the dynamic pressure is calculated using following formula:

Dynamic pressure (P)=(1/2)*p*v² (4)

Further, in such embodiment, ‘p’ is density of the air which is a pre-defined constant and upon substitution of a value of the pre-defined constant ‘p’ and the value of ‘v’ from the equation (3), the value of the dynamic pressure in newton/meter² (N/m²) obtained is about:

Pd=(1/2)*1.225*(57.79)²=2045.56 N/m² (5)

Further, in such embodiment, a wind load on the multiple blades 230 is calculated using following formula:

Wind load (F)=(A/2)*Pd*Cd (6)

In such embodiment, ‘Cd’ is a coefficient of drag which is a pre-defined constant. Further, upon substitution of the value of ‘A’, the value of ‘P’ and the value of the pre-defined constant ‘Cd’ in the equation (6), the value of the wind load (Cd) obtained is about:

F=((0.140*0.140)/2)*2045.56*1.4=56.14 N/m² (7)

Further, in such embodiment, theoretical rotation speed of the rotor 220 is calculated using following formula:

v=3.14*D*N/60 (8)

In such embodiment, ‘D’ is diameter of the rotor 220 and ‘N’ is the theoretical rotation speed of the rotor 220. Further, upon substitution of the value of ‘v’ and the value of ‘D’, the value of ‘N’ in rotations per minute (RPM) obtained is about:

57.79=3.142*0.450*N/60

N=2452.365 RPM≈2450 RPM (9)

However, in one embodiment, the pre-defined rotation speed of the rotor 220 is assumed to be 1200 RPM which is about 50% lower to the theoretical rotation speed of the rotor 220. In such embodiment, such an assumption is due the fact that the wind load is not on a tip of the rotor 220 but is forcing onto the multiple blades 230 of the rotor 220. Further, with such assumption, a torque is calculated using following formula:

Torque (T)=MI*pre-defined rotation speed of the rotor in radians/second (10)

In one embodiment, the moment of inertia of the rotor 220 is 1.15 kilogram meter square (kg m²). In one embodiment, when the pre-defined rotation speed of the rotor 220 assumed is 1200 RPM, the pre-defined rotation speed of the rotor 220 in radians/second (rad/s) is calculated as follows:

1 RPM=0.104719755 rad/s

1200 RPM=1200*0.104719755=125.66 rad/s (11)

Further, upon substitution of the value of ‘MI’ and the pre-defined rotation speed of the rotor 220 in rad/s in the equation (10), the value for the torque obtained is about:

$$T = 1.15 * 125.66 = 144.51 kgm = 1417.19 Nm \qquad ( 12 )$$

In such embodiment, the value of torque obtained is about 144.51 kilogram meter (kgm) or is about 1417.19 newton meter (Nm). In one embodiment, upon practical implementation of the apparatus 10 and during dry run of the rotor 220, a practical rotation speed of the rotor 220 obtained is about 1065 RPM. Further, in one embodiment, upon mechanically coupling the rotor 220 with the electricity generator 170, the pre-defined rotation speed of the rotor 220 is assumed to be 500 RPM. In such embodiment, the value of the torque will be about 590.50 Nm. Further, an output power generated by the electricity generator 170 for such value of the torque is calculated using following formula:

Output power=T*pre-defined rotation speed of the rotor/9.5455 (13)

Further, upon substitution of the value of the pre-defined rotation speed of the rotor 220 assumed and the value of the torque obtained in the equation (13), the value of the output power in kilo watt (kW) obtained is about:

Output power=590.50*500/9.5455+30.92 kW≈31 kW (14)

Further, in one embodiment, according to Betz limit formula, the output power would be calculated using following formula:

Output power=(½)*p*A¹*Cp*v³ (15)

In such embodiment, ‘p’ is the density of the air, ‘A¹’ is the area of the rotor 220, ‘Cp’ is a coefficient of power and ‘v’ is an air flow velocity. In such embodiment, the coefficient of the power is a pre-defined constant with a value of 0.593 which is Betz limit value of 59.3%. Further, in such embodiment, upon substitution in the equation (15), the value of the output power obtained would be about:

$$Output power = \frac{1}{2} * 1.225 * 1 * 0.45 * 0.593 * {( 57.79 )}^{3} = 31.545 kW \approx 31.55 kW \qquad ( 16 )$$

Further, in such embodiment, the value obtained in the equation (14) and the value obtained in the equation (16) matches. Further, the output power value thus obtained can be improved by enclosing the rotor 220 within a metal casing 250. In such embodiment, the metal casing 250 includes a thin mild steel (MS) sheet. In one embodiment, a diameter of the metal casing 250 enclosing the rotor 220 is about 556 mm. In one embodiment, the rotor 220 has multiple designs, multiple shapes, multiple sizes, multiple modifications and the like. Further, in one embodiment, the output power generated by the electricity generator 170 is used to recharge the power supply unit 40 initially used to power the air handling unit 20.

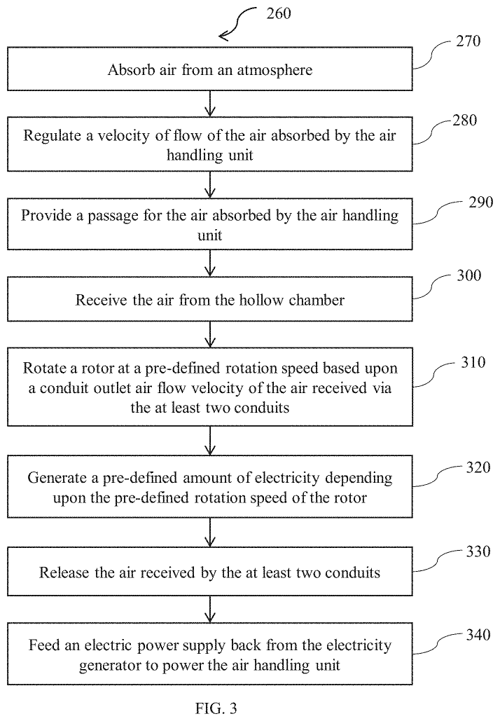

FIG. 3 is a flow chart representing steps involved in a method 260 for electricity generation in accordance with an embodiment of the present disclosure. The method 260 includes absorbing air from an atmosphere in step 270. In one embodiment, absorbing the air from the atmosphere includes absorbing the air from the atmosphere by the air handling unit. In such embodiment, absorbing the air from the atmosphere includes the air handling unit including one or more motors. The method 260 also includes regulating a velocity of flow of the air absorbed by the air handling unit in step 280. In one embodiment, regulating the velocity of the flow of the air absorbed by the air handling unit includes regulating the velocity of the air by the air handling unit. In such embodiment, absorbing the air from the atmosphere includes the air handling unit being initially powered by a power supply unit. In one exemplary embodiment, the power supply unit includes a battery. In one embodiment, the battery includes a rechargeable battery. In an alternate embodiment, the battery includes a non-rechargeable battery.

Further, the method 260 also includes providing a passage for the air absorbed by the air handling unit in step 290. In one embodiment, providing the passage for the air absorbed by the air handling unit includes providing the passage for the air absorbed by the air handling unit by a hollow chamber. In such embodiment, providing the passage for the air absorbed by the air handling unit by the hollow chamber includes the hollow chamber having a pre-fined length including a first end and a second end. In one embodiment, providing the passage for the air absorbed by the air handling unit includes the hollow chamber including a cross-sectional area that is progressively decreasing from the first end of the hollow chamber to the second end of the hollow chamber.

Furthermore, the method 260 includes receiving the air from the hollow chamber in step 300. In one embodiment, receiving the air from the hollow chamber includes receiving the air from the hollow chamber by at least two conduits. Furthermore, the method 260 also includes rotating a rotor at a pre-defined rotation speed based upon a conduit outlet air flow velocity of the air received via the at least two conduits in step 310.

Furthermore, the method 260 also includes generating a pre-defined amount of electricity depending upon the pre-defined rotation speed of the rotor 320. In such embodiment, generating the pre-defined amount of electricity depending upon the pre-defined rotation speed of the rotor includes generating the pre-defined amount of electricity depending upon the pre-defined rotation speed of the rotor by an electricity generator.

In one exemplary embodiment, generating the pre-defined amount of electricity depending upon the pre-defined rotation speed of the rotor includes generating the pre-defined amount of electricity depending upon the pre-defined rotation speed of the rotor, wherein the rotor and the electricity generator are included in an electric power generation unit. In such embodiment, generating the pre-defined amount of electricity depending upon the pre-defined rotation speed of the rotor includes generating the pre-defined amount of electricity depending upon the pre-defined rotation speed of the rotor, wherein the rotor is mechanically coupled to the electricity generator via a rotating shaft.

Furthermore, the method 260 also includes releasing the air received by the at least two conduits 330. In such embodiment, releasing the air received by the at least two conduits include releasing the air received by the at least two conduits by multiple outlets. In one embodiment, releasing the air received by the at least two conduits by multiple outlets include releasing the air received by the at least two conduits by multiple outlets, wherein the multiple outlets include multiple holes on a surface of the electric power generation unit.

Furthermore, the method 260 also includes feeding back an electric power supply from the electricity generator to power the air handling unit in step 340. In one embodiment, feeding back the electric power supply from the electricity generator to power the air handling unit includes feeding back the electric power supply from the electricity generator to power the air handling unit by a power management unit. In such embodiment, feeding back the electric power supply from the electric power generation unit to power the air handling unit includes feeding back the electric power supply from the electric power generation unit to power the air handling unit via a changeover switch upon generation of the pre-defined amount of the electricity by the electricity generator.

Various embodiments of the apparatus and the method for electricity generation enable usage of wind energy even in absence of wind by regulating the velocity of the flow of the air in the atmosphere. Further, the apparatus is environment friendly as the apparatus uses wind energy and can generate electricity at any place, any time without using any fossil fuel, thereby making the apparatus more reliable, and more efficient. Moreover, the apparatus requires minimum maintenance because of a compact size of the apparatus, thereby making the apparatus cost effective. Also, the apparatus is self-power generating and hence the apparatus is mobile and can be designed to fit in any four-wheelers such as car, bus, truck and the like thus, providing an alternative means for engines.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependant on other acts may be performed in parallel with the other acts. The scope of embodiments is by no means limited by these specific examples.

We claim:

1. An apparatus for electricity generation, wherein the apparatus comprises:
an air handling unit configured to:
absorb air from an atmosphere; and
regulate a velocity of flow of the air absorbed by the air handling unit;
a hollow chamber of a pre-defined length comprising a first end and a second end, wherein the first end of the hollow chamber is mechanically coupled to the air handling unit, wherein the hollow chamber is configured to provide a passage for the air absorbed by the air handling unit;
at least two conduits comprising an inlet end and an outlet end respectively, wherein the at least two conduits are configured to receive the air from the hollow chamber, wherein the inlet end of each of the at least two conduits is mechanically coupled to a lateral surface of the hollow chamber;
an electric power generation unit mechanically coupled to the outlet inlet end of each of the at least two conduits, wherein the electric power generation unit comprises:
a rotor configured to rotate at a pre-defined rotation speed based upon a conduit outlet air flow velocity of the air received via the at least two conduits;
an electricity generator configured to generate a pre-defined amount of electricity depending upon the pre-defined rotation speed of the rotor, wherein the electricity generator is mechanically coupled to the rotor via a rotating shaft; and
a plurality of outlets on a surface of the electric power generation unit, wherein the plurality of outlets is configured to release the air received by the at least two conduits; and
a power management unit electrically coupled to the electric power generation unit, wherein an electric power supply from the electricity generator is fed back to power the air handling unit.

2. The apparatus as claimed in claim 1, wherein the air handling unit is initially powered by a power supply unit.

3. The apparatus as claimed in claim 1, wherein the electric power supply from the electricity generator is fed back to power the air handling unit via a changeover switch upon generation of the pre-defined amount of the electricity by the electricity generator.

4. The apparatus as claimed in claim wherein the air handling unit comprises one or more motors.

5. The apparatus as claimed in claim 1, wherein the hollow chamber comprises a cross-sectional area that is progressively decreasing from the first end of the hollow chamber to the second end of the hollow chamber.

6. The apparatus as claimed in claim 1, wherein the rotor comprises a pre-defined number of blades.

7. A method for electricity generation, wherein the method comprises:
absorbing, by an air handling unit, air from an atmosphere;
regulating, by the air handling unit, a velocity of flow of the air absorbed by the air handling unit;
providing, by a hollow chamber, a passage for the air absorbed by the air handling unit;
receiving, by at least two conduits, the air from the hollow chamber;
rotating a rotor at a pre-defined rotation speed based upon a conduit outlet air flow velocity of the air received via the at least two conduits;
generating, by an electricity generator, a pre-defined amount of electricity depending upon the pre-defined rotation speed of the rotor;
releasing, by a plurality of outlets, the air received by the at least two conduits; and
feeding, by a power management unit, back an electric power supply from the electricity generator to power the air handling unit.

8. The method as claimed in claim 7, wherein the absorbing, by the air handling unit, the air from the atmosphere comprises the air handling unit being initially powered by a power supply unit.

9. The method as claimed in claim 7, wherein feeding, by the power management unit, back the electric power supply from the electricity generator to power the air handling unit comprises feeding, by the power management unit, back the electric power supply from the electricity generator to power the air handling unit via a changeover switch upon generation of the pre-defined amount of the electricity by the electricity generator.

10. The method as claimed in claim 7, wherein the absorbing, by the air handling unit, the air from the atmosphere comprises the air handling unit comprising one or more motors.
